(19) United States
(12) Patent Application Publication
(10) Pub. No.: US 2014/0242371 A1
(43) Pub. Date: Aug. 28, 2014

(54) RESIN FOAM SHEET AND RESIN FOAM COMPOSITE MATERIAL

(71) Applicants: Itsuhiro Hatanaka, Ibaraki-shi (JP); Makoto Saitou, Ibaraki-shi (JP); Kazumichi Kato, Ibaraki-shi (JP)

(72) Inventors: Itsuhiro Hatanaka, Ibaraki-shi (JP); Makoto Saitou, Ibaraki-shi (JP); Kazumichi Kato, Ibaraki-shi (JP)

(73) Assignee: NITTO DENKO CORPORATION, Ibaraki-shi, Osaka (JP)

(21) Appl. No.: 14/349,810

(22) PCT Filed: Sep. 10, 2012
(86) PCT No.: PCT/JP2012/073071

§ 371 Date: Apr. 4, 2014

(30) Foreign Application Priority Data
Oct. 11, 2011 (JP) 2011-224026
Sep. 7, 2012 (JP) 2012-196779

(51) Int. Cl. C08L 23/12; C09J 7/02

(52) U.S. Cl. CPC C08L 23/12; C09J 7/0289
USPC 428/220; 428/317.3

(57) ABSTRACT

There is provided a resin foam sheet low in the apparent density and thin and flexible, and excellent in the stability in winding-up (wind-up stability). The resin foam sheet according to the present invention has an apparent density of 0.03 to 0.30 g/cm³, a compression stress at 50%-compression of not more than 5.0 N/cm², a thickness of not less than 0.05 mm and not more than 0.40 mm, a length of not less than 5 m, and a width of not less than 300 mm. The value determined by the following expression (1) of the resin foam sheet is preferably not more than 25%.

(Thickness Tolerance)/(Central Value of Thicknesses)×100 (1)

### TECHNICAL FIELD

The present invention relates to a resin foam sheet and a resin foam composite material containing the resin foam sheet.

### BACKGROUND ART

Resin foams are used as sealing materials and buffer materials for electronic devices as well as buffer materials, heat insulating materials for transportation, packaging materials and building materials. In recent years, the areas of resin foams used as the sealing materials and buffer materials have become small along with down-sizing of electronic devices and up-sizing of screens, and the resin foams are required to have flexibility exhibiting a sufficient sealing property and buffer property even if having small areas. Also the thickness reduction is progressing in electronic devices, and also the thickness reduction is then required for the resin foams.

As thin resin foams, foam sheets are known which are obtained by a method of carrying out a compression treatment or a stretching treatment during foaming or in later steps or a method of carrying out a coating treatment after foaming (for example, see Patent Literature 1 and Patent Literature 2). However, a problem of the foam sheets is that the expansion ratio is difficult to lower, and another problem is that when being compressed, the repulsive force is large, including that the repulsive force (repulsive stress at 25%-compression) at 25% compression is more than 3 N/cm².

In recent years, design gaps (spacings) where resin foams are used have become very narrow (for example, gap of 0.1 mm) along with the thickness reduction of mobile devices, and it is not seldom that the resin foams are compressed to not less than 50% and used in consideration of the design tolerance and the like. However, if the resin foams exhibiting a large repulsive force when being compressed are used for such very narrow design gaps of display devices, for example, displaying unevenness is generated on liquid crystals of display sections because of its high repulsive force, and displaying faults are caused in some cases.

### CITATION LIST

### Patent Literature

Patent Literature 1: Japanese Patent Laid-Open No. 2009-190195
Patent Literature 2: Japanese Patent Laid-Open No. 2010-1407

### SUMMARY OF INVENTION

### Technical Problem

Resin foams, when being distributed in the market, are continuously wound up, and assume roll-shape forms such as “continuous rolls” and “long rolls” in many cases. Therefore, resin foams are preferably capable of being stably wound up without generating wrinkles and the like when being wound up.

Therefore, it is an object of the present invention to provide a resin foam sheet being low in the apparent density, being thin and flexible, and being excellent in the stability in winding-up (wind-up stability).

In recent years, since a large number of members are stacked in devices like smart phones mounting touch panels, not only the thickness reduction but also the reduction of the thickness tolerance of each member have been required. Therefore, for resin foams used for the above devices, a high thickness precision is required.

Therefore, it is another object of the present invention to provide a resin foam sheet being low in the apparent density, being thin and flexible, being excellent in the wind-up stability, and further being excellent in the thickness precision.

### Solution to Problem

As a result of exhaustive studies to achieve the above objects, the present inventors have found that by melting a part in the thickness direction of a resin foam to return the part to a bulk (in a non-foamed state), a thin resin foam sheet can be obtained while the strength of the resin foam sheet is held and the decrease in physical properties such as flexibility is suppressed. It has been further found that by melting a part in the thickness direction of a resin foam to return the part to a bulk (in a non-foamed state), a resin foam sheet excellent in the thickness precision in addition to the above can be obtained. The present invention has been achieved based on these findings.

That is, the present invention provides a resin foam sheet having an apparent density of 0.03 to 0.30 g/cm³, a compression stress at 50%-compression of not more than 5.0 N/cm², a thickness of not less than 0.05 mm and not more than 0.40 mm, a length of not less than 5 m, and a width of not less than 300 mm.

The above resin foam sheet preferably has a value determined by the following expression (1) of not more than 25%.

(Thickness Tolerance)/(Central Value of Thicknesses)×100 (1)

Thickness Tolerance: which refers to a difference between the maximum value and the minimum value in all measurement values acquired by the measurement in which the thicknesses are measured every 10 mm from one edge to the other edge in the width direction at a point in the longitudinal direction, and the thicknesses are further measured every 10 mm from one edge to the other edge in the width direction at a point moved in the longitudinal direction by 1 m from the former point.

Central Value of Thicknesses: which refers to a value positioned at the center in all measurement values arranged in ascending order acquired by the measurement in which the thicknesses are measured every 10 mm from one edge to the other edge in the width direction at a point in the longitudinal direction, and the thicknesses are further measured every 10 mm from one edge to the other edge in the width direction at a point moved in the longitudinal direction by 1 m from the former point.

At least one surface of the resin foam sheet preferably has a rate of surface coverage defined by the following expression (2) of not less than 40%.

Rate of surface coverage(%)=[(Area of Surface)−(Area of Pores Present on the Surface)]/(the Area of the Surface)×100 (2)

The resin foam sheet is formed preferably by foaming a resin composition and further subjecting the surface thereof to a heat melting treatment.

The present invention further provides a resin foam composite material having the resin foam sheet and a pressure-sensitive adhesive layer at least on one surface side of the resin foam sheet.

### Advantageous Effects of Invention

The resin foam sheet according to the present invention, since having the above constitution, is low in the apparent density and is thin and flexible. The resin foam sheet is also excellent in the wind-up stability. The resin foam sheet can further provide a high thickness precision.

### BRIEF DESCRIPTION OF DRAWINGS

FIG. 1 is a schematic diagram of a continuous slicing apparatus.

FIG. 2 is a schematic diagram of a continuous treatment apparatus having a heating roll.

### DESCRIPTION OF EMBODIMENTS

### [Resin Foam Sheet]

The resin foam sheet according to the present invention is a sheet-shape material of a resin foam. The resin foam sheet according to the present invention may be wound up and be of a roll-shape (wound body). In the present description, the “resin foam sheet having an apparent density of 0.03 to 0.30 g/cm³, a compression stress at 50%-compression of not more than 5.0 N/cm², a thickness of not less than 0.05 mm and not more than 0.40 mm, a length of not less than 5 m, and a width of not less than 300 mm” is referred to as the “long resin foam sheet according to the present invention” in some cases.

The thickness of the long resin foam sheet according to the present invention is not less than 0.05 mm and not more than 0.40 mm, preferably not less than 0.07 mm and not more than 0.30 mm, and more preferably not less than 0.10 mm and not more than 0.25 mm. Since the thickness is not less than 0.05 mm, a necessary strength can be secured, which is preferable. Further since the thickness is not more than 0.40 mm, the function of a resin foam can be exhibited even if the gap is small, which is preferable.

The thickness is an average value of all measurement values acquired by the measurement in which the thicknesses are measured every 10 mm from one edge to the other edge in the width direction at a point in the longitudinal direction of the resin foam sheet, and the thicknesses are further measured every 10 mm from one edge to the other edge in the width direction at a point moved in the longitudinal direction by 1 m from the former point.

The width of the long resin foam sheet according to the present invention is not less than 300 mm (for example, 300 to 1,500 mm), preferably not less than 400 mm (for example, 400 to 1,200 mm), and more preferably not less than 500 mm (for example, 500 to 1,000 mm). Since the width is not less than 300 mm, flexible designing and processing can be carried out, which is preferable.

The length of the long resin foam sheet according to the present invention is not less than 5 m (for example, 5 to 1,000 m), preferably not less than 30 m (for example, 30 to 500 m), and more preferably not less than 50 m (for example, 50 to 300 m).

The apparent density (density) of the long resin foam sheet according to the present invention is 0.03 to 0.30 g/cm³, more preferably 0.04 to 0.25 g/cm³, and still more preferably 0.05 to 0.20 g/cm³. Since the apparent density is not less than 0.03 g/cm³, the strength can be secured, which is preferable. Since the apparent density is not more than 0.30 g/cm³, good flexibility can be provided, which is preferable.

The compression stress at 50%-compression of the long resin foam sheet according to the present invention is not more than 5.0 N/cm², more preferably not more than 4.0 N/cm², and still more preferably not more than 3.0 N/cm². If the compression stress at 50%-compression is not more than 5.0 N/cm², good flexibility can be provided and the repulsive force when being compressed can be reduced, which is preferable.

The compression stress at 50%-compression is determined based on JIS K 6767 by measuring a stress (N) when a resin foam sheet is compressed by 50% of the initial thickness in the thickness direction, and converting the stress to a value per unit area (cm²).

The tensile strength of the long resin foam sheet according to the present invention is not especially limited, but is preferably not less than 0.5 MPa (for example, 0.5 to 15 MPa), and more preferably not less than 0.7 MPa (for example, 0.7 to 10 MPa). If the tensile strength is not less than 0.5 MPa, the strength is excellent and even if a force is exerted in the longitudinal direction when the resin foam sheet is made and used, breakage and tearing are suppressed, which is preferable.

The tensile strength is a tensile strength in the longitudinal direction of a resin foam sheet, and determined based on JIS K 6767.

In the long resin foam sheet according to the present invention, the value determined from the following expression (1) is preferably not more than 25%, more preferably not more than 15%, and still more preferably not more than 10%.

(Thickness Tolerance)/(Central Value of Thicknesses)×100 (1)

Thickness Tolerance: which refers to a difference between the maximum value and the minimum value in all measurement values acquired by the measurement in which the thicknesses are measured every 10 mm from one edge to the other edge in the width direction at a point in the longitudinal direction, and the thicknesses are further measured every 10 mm from one edge to the other edge in the width direction at a point moved in the longitudinal direction by 1 m from the former point.

Central Value (Median Value) of Thicknesses: which refers to a value positioned at the center in all measurement values arranged in in ascending order acquired by the measurement in which the thicknesses are measured every 10 mm from one edge to the other edge in the width direction at a point in the longitudinal direction, and the thicknesses are further measured every 10 mm from one edge to the other edge in the width direction at a point moved in the longitudinal direction by 1 m from the former point.

If the “value determined by the expression (1)” is not more than 25%, generation of wrinkles in winding-up, particularly generation of wrinkles in high-speed winding-up, is suppressed, and good wind-up stability can be provided, which is preferable. Also a high thickness precision can be provided, which is preferable. In the present description, the high-speed in winding-up refers to a speed of, for example, 10 to 40 m/min.

In the long resin foam sheet according to the present invention, at least one surface is preferably a surface having a rate of surface coverage of not less than 40% from the viewpoints that generation of wrinkles in winding-up, particularly generation of wrinkles in high-speed winding-up, is to be suppressed, and good wind-up stability is to be provided, and that a high thickness precision is to be provided. That is, the long resin foam sheet according to the present invention preferably has a surface having a rate of surface coverage of not less than 40%.

The rate of surface coverage is preferably not less than 40%, more preferably not less than 45%, and still more preferably not less than 50%, from the viewpoints that a better wind-up stability is to be provided, and that a higher thickness precision is to be provided.

The rate of surface coverage is an index to indicate a proportion of a non-pore portion (a portion excluding pores present on the surface, a bulk, a portion in a non-foamed state) present on the surface, and is defined by the following expression (2). If the rate of surface coverage is 100%, it means that no pore portion is present on the surface.

Rate of surface coverage(%)=[(Area of Surface)−(Area of Pores Present on the Surface)]/(the Area of the Surface)×100 (2)

The long resin foam sheet according to the present invention is not especially limited in its formation, but is preferably formed by foaming a resin composition containing a resin. The long resin foam sheet according to the present invention is preferably formed by foaming a polyolefin-based resin composition containing a polyolefin-based resin, among resins. That is, the long resin foam sheet according to the present invention is preferably a long polyolefin-based resin foam sheet. The resin composition may contain, in addition to a resin, other components and additives. The resin, the other components, the additives and the like may each be used singly or in combinations of two or more.

The content of a resin in the resin composition is not especially limited, but is preferably not less than 50 wt %, and more preferably not less than 60 wt %, with respect to the total amount (100 wt %) of the resin composition.

The cell structure of the long resin foam sheet according to the present invention is not especially limited, but is preferably a closed cell structure or a semi-open semi-closed cell structure (a mixed cell structure of a closed cell structure and an open cell structure, and the proportions are not especially limited), and is more preferably a semi-open semi-closed cell structure. The proportion of a closed cell structure part of the long resin foam sheet according to the present invention is not especially limited, but is preferably not more than 40%, and more preferably not more than 30%, with respect to the total volume (100%) of the long resin foam sheet according to the present invention, from the viewpoint of flexibility. A cell structure can be controlled, for example, by regulating the expansion ratio by the amount and the pressure of a blowing agent with which a resin composition is impregnated, in foam molding.

The average cell diameter in a cell structure of the long resin foam sheet according to the present invention is not especially limited, but is, for example, preferably 10 to 150 μm, and more preferably 30 to 120 μm. Making the average cell diameter of a foam to be not less than 10 μm improves the impact absorbing property (cushioning property). Making the average cell diameter of a foam to be not more than 150 μm makes the foam have micro cells. The condition further enables the foam to be used for a micro clearance, and further improves dustproofness.

The polyolefin-based resin contained in the polyolefin-based resin composition is not especially limited, but is preferably a polymer constituted (formed) of an α-olefin as an essential monomer component, that is, a polymer having at least a structural unit originated from an α-olefin in one molecule thereof. The polyolefin-based resin may be, for example, a polymer constituted only of an α-olefin, or may be a polymer constituted of an α-olefin and a monomer component other than the α-olefin.

The polyolefin-based resin may be a homopolymer or a copolymer containing two or more monomers. In the case where the polyolefin-based resin is a copolymer, the copolymer may be a random copolymer or a block copolymer. The polyolefin-based resin may be a single polymer or a combination of two or more polymers.

The polyolefin-based resin is not especially limited, but is preferably a straight-chain polyolefin from the viewpoint of providing a polyolefin-based resin foam having a high expansion ratio.

Examples of the α-olefin include α-olefins having 2 to 8 carbon atoms (ethylene, propylene, butane-1, pentene-1, hexene-1,4-methyl-pentene-1, heptene-1, octene-1 and the like). The α-olefin may be used singly or in combinations of two or more.

Examples of monomer components other than the α-olefin include ethylenic unsaturated monomers such as vinyl acetate, acrylic acid, acrylate esters, methacrylic acid, methacrylate esters and vinyl alcohol. The monomer components other than the α-olefin may be used singly or in combinations of two or more.

Examples of the polyolefin-based resin include low-density polyethylenes, middle-density polyethylenes, high-density polyethylenes, linear low-density polyethylenes, polypropylenes (propylene homopolymers), copolymers of ethylene and propylene, copolymers of ethylene and an α-olefin other than ethylene, copolymers of propylene and an α-olefin other than propylene, copolymers of ethylene, propylene and an α-olefin other than ethylene and propylene, and copolymers of propylene and an ethylenic unsaturated monomer.

The polyolefin-based resin is preferably a polymer (polypropylene-based polymer) constituted of propylene as an essential monomer component, that is, a polymer having at least a structural unit originated from propylene, from the viewpoint of heat resistance. That is, examples of the polyolefin-based resin include polypropylene-based polymers such as polypropylenes (propylene homopolymers), copolymers of ethylene and propylene, and copolymers of propylene and an α-olefin other than propylene. The α-olefin other than propylene may be used singly or in combinations of two or more.

The content of the α-olefin is not especially limited, but is, for example, preferably 0.1 to 10 wt %, and more preferably 1 to 5 wt %, with respect to the total amount (100 wt %) of the monomer components constituting the polyolefin-based resin.

The polyolefin-based resin composition may contain, in addition to the polyolefin-based resin, a “rubber and/or thermoplastic elastomer” as other components.

The rubber is not especially limited, but examples thereof include natural or synthetic rubbers such as natural rubbers, polyisobutylenes, isoprene rubbers, chloroprene rubbers, butyl rubbers and nitrile butyl rubbers. The rubber may be used singly or in combinations of two or more.

The thermoplastic elastomer is not especially limited, but examples thereof include thermoplastic olefin-based elastomers such as ethylene-propylene copolymers, ethylene-propylene-diene copolymers, ethylene-vinyl acetate copolymers, polybutenes, polyisobutylenes and chlorinated polyethylenes; thermoplastic styrene-based elastomers such as styrene-butadiene-styrene copolymers, styrene-isoprene-styrene copolymers, styrene-isoprene-butadiene-styrene copolymers and hydrogenated polymers thereof; thermoplastic polyester-based elastomers; thermoplastic polyurethane-based elastomers; and thermoplastic acrylic elastomers. The thermoplastic elastomer may be used singly or in combinations of two or more.

The content of the “rubber and/or thermoplastic elastomer” in the polyolefin-based resin composition is not especially limited, but preferably 0 to 70 wt %, more preferably 20 to 60 wt %, and still more preferably 20 to 50 wt %, with respect to the total amount (100 wt %) of the polyolefin-based resin composition.

The polyolefin-based resin composition may further contain, in addition to the polyolefin-based resin, a “mixture (composition) containing a rubber and/or thermoplastic elastomer, and a softening agent” as other components. The “mixture (composition) containing a rubber and/or thermoplastic elastomer, and a softening agent”, as required, may contain additives.

Examples of the “mixture (composition) containing a rubber and/or thermoplastic elastomer, and a softening agent” include mixtures containing at least a rubber, a thermoplastic elastomer and a softening agent, mixtures containing at least a rubber and a softening agent, and mixtures containing at least a thermoplastic elastomer and a softening agent. Among these, a “mixture composed only of a rubber and/or thermoplastic elastomer, and a softening agent” is preferable.

The rubber in the “mixture containing a rubber and/or thermoplastic elastomer, and a softening agent” is not especially limited, but preferably includes the rubbers exemplified as rubbers of the “rubber and/or thermoplastic elastomer”. The rubber may be used singly or in combinations of two or more.

The rubber and/or thermoplastic elastomer in the “mixture containing a rubber and/or thermoplastic elastomer, and a softening agent” is not especially limited as long as being expandable, but examples thereof include well-known customary “rubbers and/or thermoplastic elastomers”. Among these, the thermoplastic elastomer exemplified as a thermoplastic elastomer of the “rubber and/or thermoplastic elastomer” is preferably included. The thermoplastic elastomer may be used singly or in combinations of two or more.

As a “rubber and/or thermoplastic elastomer” in the “mixture containing a rubber and/or thermoplastic elastomer, and a softening agent”, an olefin-based elastomer is preferable, and especially preferable is an olefin-based elastomer having a structure in which a polyolefin component and an olefin-based rubber component are microphase-separated. The olefin-based elastomer having a structure in which a polyolefin component and an olefin-based rubber component are microphase-separated is exemplified preferably by an elastomer comprising a polypropylene resin (PP) and an ethylene-propylene rubber (EPM) or an ethylene-propylene-diene rubber (EPDM). The mass ratio of the polyolefin component to the olefin-based rubber component is preferably the polyolefin component/the olefin-based rubber component=90/10 to 10/90, and more preferably 80/20 to 20/80, from the viewpoint of compatibility.

The softening agent is not especially limited, but preferably includes softening agents commonly used for rubber products. Incorporation of the softening agent can improve processability and flexibility.

Specific examples of the softening agent include petroleum-based substances such as process oils, lubricating oils, paraffins, liquid paraffins, petroleum asphalts and vaselines; coal tars such as coal tars and coal tar pitches; fatty oils such as castor oils, linseed oils, rapeseed oils, soybean oils and coconut oils; waxes such as tall oils, beeswaxes, carnauba waxes and lanolins; synthetic polymeric substances such as petroleum resins, coumarone indene resins and atactic polypropylenes; ester compounds such as dioctyl phthalate, dioctyl adipate and dioctyl sebacate; microcrystalline waxes, rubber substitutes (factices), liquid polybutadienes, modified liquid polybutadienes, liquid thiokols, liquid polyisoprenes, liquid polybutenes, and liquid ethylene-α-olefin-based copolymers. Among these, preferable are paraffin-based, naphthene-based or aromatic mineral oils, and liquid polyisoprenes, liquid polybutenes, and liquid ethylene-α-olefin-based copolymers, and more preferable are liquid polyisoprenes, liquid polybutenes and liquid ethylene-α-olefin-based copolymers.

The content of the softening agent in the “mixture containing a rubber and/or thermoplastic elastomer, and a softening agent” is not especially limited, but preferably 1 to 200 parts by mass, more preferably 5 to 100 parts by mass, and still more preferably 10 to 50 parts by mass, with respect to 100 parts by mass of the polyolefin component. If the content of a softening agent is too much, defective dispersion is caused in kneading with the rubber and/or thermoplastic elastomer in some cases.

Additives in the “mixture containing a rubber and/or thermoplastic elastomer, and a softening agent” are not especially limited, but examples thereof include antiaging agents, weather-resistive agents, ultraviolet absorbents, dispersants, plasticizers, carbon blacks, antistatics, surfactants, tension-modifying agents and fluidity-modifying agents. Such additives may be used singly or in combinations of two or more.

The content of the additives in the “mixture containing a rubber and/or thermoplastic elastomer, and a softening agent” is not especially limited, but, for example, preferably 0.01 to 100 parts by mass, more preferably 0.05 to 50 parts by mass, and still more preferably 0.1 to 30 parts by mass, with respect to 100 parts by mass of the polyolefin component. Making the content to be not less than 0.01 parts by mass easily develops the effect of addition of the additives, which is preferable.

The melt flow rate (MFR) (230° C.) of the “mixture containing a rubber and/or thermoplastic elastomer, and a softening agent” is not especially limited, but is preferably 3 to 10 g/10-min, and more preferably 4 to 9 g/10-min, from the viewpoint of providing good moldability.

The “JIS A hardness” of the “mixture containing a rubber and/or thermoplastic elastomer, and a softening agent” is not especially limited, but is preferably 30 to 90°, and more preferably 40 to 85°. If the “JIS A hardness” is not less than 30°, a resin foam having a high expansion ratio is easily obtained, which is preferable. If the “JIS A hardness” is not more than 90°, a flexible resin foam is easily obtained, which is preferable. The “JIS A hardness” in the present description refers to a hardness measured based on ISO 7619 (JIS K 6253).

The polyolefin-based resin composition may further contain additives in the range of not spoiling the advantage of the present invention. Examples of the additives include cell nucleating agents, crystal nucleating agents, plasticizers, lubricants, colorants (pigments, dyes and the like), ultraviolet absorbents, antioxidants, antiaging agents, fillers, reinforcing agents, antistatics, surfactants, tension-modifying agents, shrinkage-preventing agents, fluidity-modifying agents, clays, vulcanizing agents, surface-treating agents and flame retardants. The additives may be used singly or in combinations of two or more.

Since the incorporation of the cell nucleating agent in the resin composition enables to easily provide a resin foam having a uniform micro cell structure, the polyolefin-based resin composition preferably contains a cell nucleating agent.

Examples of the cell nucleating agent include particles. Examples of the particles include talc, silica, alumina, zeolite, calcium carbonate, magnesium carbonate, barium sulfate, zinc oxide, titanium oxide, aluminum hydroxide, magnesium hydroxide, mica, clays such as montmorillonite, carbon particles, glass fibers and carbon tubes. The particles may be used singly or in combinations of two or more.

The content of the cell nucleating agent in the polyolefin-based resin composition is not especially limited, but is preferably 0.5 to 125 parts by weight, and more preferably 1 to 120 parts by weight, with respect to 100 parts by weight of the polyolefin-based resin.

The average particle diameter of the particle is not especially limited, but is preferably 0.1 to 20 μm. If the average particle diameter is less than 0.1 μm, the particle does not function as a cell nucleating agent in some cases; and by contrast, if the particle diameter is more than 20 μm, gas escape in foam molding is caused in some cases.

Incorporation of the flame retardant in the resin composition makes the resin foam of flame retardancy, and the resin foam can be used in applications requiring flame retardancy such as electric or electronic device applications. Therefore, the polyolefin-based resin composition may contain a flame retardant.

The flame retardant may be in a powder-form, or in a form other than powder-form. A powder-form flame retardant is preferably an inorganic flame retardant. Examples of the inorganic flame retardant include bromine-based flame retardants, chlorine-based flame retardants, phosphorus-based flame retardants, antimony-based flame retardants and non-halogen non-antimony-based inorganic flame retardants. Here, the chlorine-based flame retardants and the bromine-based flame retardants generate gas components hazardous to human bodies and corrosive to devices in combustion, and the phosphorus-based flame retardants and the antimony-based flame retardants have problems such as hazardousness and explosiveness. Therefore, as the inorganic flame retardant, non-halogen non-antimony-based inorganic flame retardants are preferable. Examples of the non-halogen non-antimony-based inorganic flame retardants include hydrated metal compounds such as aluminum hydroxide, magnesium hydroxide, hydrates of magnesium oxide-nickel oxide and hydrates of magnesium oxide-zinc oxide. The hydrated metal oxide may be surface-treated. The flame retardant may be used singly or in combinations of two or more.

The flame retardant preferably has flame retardancy, and also a function as a cell nucleating agent from the viewpoint of being capable of providing a polyolefin-based resin foam having a high expansion ratio. Examples of a flame retardant having a function as a cell nucleating agent include magnesium hydroxide and aluminum hydroxide.

The content of the flame retardant in the polyolefin-based resin composition is not especially limited, but is preferably 30 to 150 parts by weight, and more preferably 60 to 120 parts by weight, with respect to 100 parts by weight of the polyolefin-based resin.

Incorporation of the lubricant in the resin composition enables to improve the fluidity of the resin composition, and suppress the thermal deterioration. Therefore, the polyolefin-based resin composition may contain a lubricant.

The lubricant is not especially limited, but examples thereof include hydrocarbon-based lubricants such as liquid paraffins, paraffin waxes, microwaxes and polyethylene waxes; fatty acid-based lubricants such as stearic acid, behenic acid and 12-hydroxystearic acid; and ester-based lubricants such as butyl stearate, monoglyceride stearate, pentaerythritol tetrastearate, hardened castor oils and stearyl stearates. The lubricant may be used singly or in combinations of two or more.

The content of the lubricant in the polyolefin-based resin composition is not especially limited, but is preferably 0.1 to 10 parts by weight, and more preferably 0.5 to 5 parts by weight, with respect to 100 parts by weight of the polyolefin-based resin.

The polyolefin-based resin composition is not especially limited, but may be made by kneading the polyolefin-based resin with other components, as required, and with additives added thereto as required. The polyolefin-based resin composition may be obtained by kneading and extrusion using a known melt kneading extruder such as a single-screw kneading extruder or a twin-screw kneading extruder.

The shape of the polyolefin-based resin composition is not especially limited, but examples thereof include a strand shape, a sheet shape, a flat plate shape and a pellet shape obtained by water- or air-cooling a strand and cutting it into a proper length. Among these, kneading and pelletizing is preferable from the viewpoint of productivity.

The long resin foam sheet according to the present invention is not especially limited, but is preferably formed by foaming the above resin composition (for example, the polyolefin-based resin composition). The long resin foam sheet is especially preferably formed by foaming the resin composition (for example, the polyolefin-based resin composition), and thereafter subjecting the surface thereof to a heat melting treatment.

A method for foaming the resin composition (for example, the polyolefin-based resin composition) is not especially limited, but examples thereof include physical foaming methods and chemical foaming methods. The physical foaming methods are methods in which a resin composition is impregnated (dispersed) with a low-boiling point liquid (blowing agent), which is then evaporated to thereby form cells. The chemical foaming methods are methods in which a gas generated by thermal decomposition of a compound added to a resin composition is caused to form cells. Among these methods, physical foaming methods are preferable, and physical foaming methods using a high-pressure gas as a blowing agent are more preferable, from the viewpoints of avoiding the contamination of a resin foam sheet and easily providing a micro uniform cell structure. Therefore, the long resin foam sheet according to the present invention is especially preferably formed by impregnating the polyolefin-based resin composition with a high-pressure gas (for example, an inert gas described later), and thereafter being caused to be foamed.

The blowing agent used in the physical foaming method is not especially limited, but is preferably a gas from the viewpoint of easily providing a micro and high-cell density cell structure, and is especially preferably an inert gas to the resin (resin contained in the above resin composition, for example, the polyolefin-based resin) constituting the resin foam sheet.

The inert gas is not especially limited, but examples thereof include carbon dioxide, nitrogen gas, air, helium and argon. The inert gas is especially preferably carbon dioxide from the viewpoint that the amount of the inert gas with which the resin composition is impregnated is large and the impregnation speed is high. The inert gas may be used singly or in combinations of two or more.

The amount (content, amount of impregnation) of the blowing agent mixed is not especially limited, but is preferably 2 to 10 wt % with respect to the total weight (100 wt %) of the resin composition.

The inert gas is preferably in a supercritical state in impregnation from the viewpoint of accelerating the impregnation speed to the resin composition. That is, the long resin foam sheet according to the present invention is preferably formed by causing the resin composition (for example, the polyolefin-based resin composition) to be foamed by using a supercritical fluid. If the inert gas is a supercritical fluid (in a supercritical state), the solubility thereof to the resin composition increases and the high-concentration impregnation (mixing) is possible. Since a high-concentration impregnation is possible, many cell nuclei are generated when the pressure is sharply reduced after the impregnation, and the density of cells grown from the cell nuclei becomes high even if the porosity is the same, whereby micro cells can be provided. The critical temperature of carbon dioxide is 31° C., and the critical pressure thereof is 7.4 MPa.

The physical foaming method using a gas as a blowing agent is preferably a forming method in which the resin composition is impregnated with a high-pressure gas (for example, an inert gas), and thereafter, foaming is carried out through a step of depressurization (for example, to the atmospheric pressure) (step of releasing the pressure). The method specifically includes a forming method in which the resin composition is molded to thereby obtain an unfoamed molded material, and the unfoamed molded material is impregnated with a high-pressure gas, and thereafter foamed through a step of depressurization (for example, to the atmospheric pressure), and a forming method in which the melted resin composition is impregnated with a gas (for example, an inert gas) under a pressurized state, thereafter caused to be foamed by depressurization (for example, to the atmospheric pressure), and molded.

That is, in the case of forming the long resin foam sheet according to the present invention, the formation may be carried out by a batch system in which the resin composition (for example, the polyolefin-based resin composition) is molded into a suitable shape such as a sheet-shape to thereby make an unfoamed resin molding (unfoamed molded material), and thereafter, the unfoamed resin molding is impregnated with a high-pressure gas, and caused to be foamed by releasing the pressure, or a continuous system in which the resin composition is kneaded with a high-pressure gas under a high-pressure condition, and molded while the pressure is simultaneously released, to thereby simultaneously carry out molding and foaming.

In the batch system, a method for forming the unfoamed resin molding is not especially limited, but examples thereof include a method in which the resin composition is molded using an extruder such as a single-screw extruder and a twin-screw extruder, a method in which the resin composition is uniformly kneaded using a roller, a cam, a kneader or a kneading machine equipped with blades such as a Banbury type, and press-molded into a predetermined thickness by using a hot plate press or the like, and a method of molding the resin composition by using an injection molding machine. The shape of the unfoamed resin molding is not especially limited, but examples thereof include a sheet-shape, a roll-shape and a plate-shape. In the batch system, the resin composition is molded by a suitable method of obtaining an unfoamed resin molding having a desired shape and thickness.

The batch system forms a cell structure through a gas impregnation step in which the unfoamed resin molding is put in a pressure vessel, and a high-pressure gas is injected (introduced, mixed) to thereby impregnate the unfoamed resin molding with the gas, and a depressurization step in which the pressure is released (usually, to the atmospheric pressure) at the time of sufficient impregnation with the gas to thereby generate cell nuclei in the resin composition.

On the other hand, the continuous system foams and molds the resin composition through a kneading impregnation step in which while the resin composition is kneaded using an extruder (for example, a single-screw extruder or a twin-screw extruder) or an injection molding machine, a high-pressure gas is injected (introduced, mixed) to thereby sufficiently impregnate the resin composition with the high-pressure gas, and a molding depressurization step in which the resin composition is extruded through a die or the like installed at the front end of the extruder to release (usually, to the atmospheric pressure) the pressure to thereby simultaneously carry out molding and foaming.

In the batch system and continuous system, as required, a heating step in which cell nuclei are grown by heating may be provided. Cell nuclei may be grown at room temperature without providing a heating step. Additionally, after cells are grown, as required, rapid cooling may be carried out by cold water or the like to thereby fix the shape. Introduction of a high-pressure gas may be carried out continuously or discontinuously. A heating method when cell nuclei are grown is not especially limited, but includes known and customary methods using a water bath, an oil bath, a hot roll, a hot air oven, far infrared rays, near infrared rays and microwaves.

The pressure at the time when the resin composition is impregnated with a gas in the gas impregnation step in the batch system and the kneading impregnation step in the continuous system is suitably selected in consideration of the kind, the operability and the like of the gas, but is, for example, preferably not less than 5 MPa (for example, 5 to 100 MPa), and more preferably not less than 7 MPa (for example, 7 to 100 MPa). That is, the resin composition is impregnated preferably with a gas of a pressure of not less than 5 MPa (for example, a pressure of 5 to 100 MPa), and more preferably with an inert gas of a pressure of not less than 7 MPa (for example, a pressure of 7 to 100 MPa). In the case where the pressure of a gas is less than 5 MPa, the cell growth in foaming is remarkable and cells become too large, and for example, trouble including a decrease in the dustproof effect is liable to be caused, which is not preferable. This is because if the pressure is low, the amount of the gas with the resin composition is impregnated is relatively small as compared to the high-pressure case, and the cell nucleus formation speed decreases and the number of cell nuclei formed becomes small, and therefore the amount of the gas per cell conversely increases to thereby make the cell diameter extremely large. In a pressure region less than 5 MPa, since the cell diameter and the cell density largely vary only by slightly varying the impregnation pressure, the control of the cell diameter and the cell density is liable to become difficult.

The temperature (impregnation temperature) at the time when the resin composition is impregnated with a gas in the gas impregnation step in the batch system and the kneading impregnation step in the continuous system depends on the kinds of the gas and a resin, and can be selected in a broad range, but is preferably 10 to 350° C. in consideration of the operability and the like. More specifically, the impregnation temperature in the batch system is preferably 10 to 250° C., more preferably 40 to 240° C., and still more preferably 60 to 230° C. In the continuous system, the impregnation temperature is preferably 60 to 350° C., more preferably 100 to 320° C., and still more preferably 150 to 300° C. In the case of using carbon dioxide as a high-pressure gas, in order to hold a supercritical state, the temperature in impregnation (impregnation temperature) is preferably not less than 32° C. (particularly not less than 40° C.). After the gas impregnation and before the foam molding, the resin composition impregnated with the gas may be cooled to a temperature (for example, 150 to 190° C.) suitable for foam molding.

Further in the batch system and in the continuous system, the depressurization speed in the depressurization step (step of releasing the pressure) is not especially limited, but is preferably 5 to 300 MPa/sec from the viewpoint of providing a cell structure having uniform micro cells.

In the case where a heating step is provided in order to grow cell nuclei, the heating temperature is, for example, preferably 40 to 250° C., and more preferably 60 to 250° C.

The cell structure, the density and the relative density of the long resin foam sheet according to the present invention are adjusted by selecting a foaming method and foaming conditions (for example, the kind and amount of a blowing agent, and the temperature, pressure, time and the like in foaming) when the resin composition is expansion-molded, according to the kind of the constituting resin.

From the above description, the long resin foam sheet according to the present invention is especially preferably formed by foaming the resin composition, and thereafter subjecting the surface thereof to a heat melting treatment. More specifically, the long resin foam sheet is preferably formed by foaming the resin composition to obtain a foam (sheet-shape foam), and thereafter subjecting the surface of the foam to a heat melting treatment. By causing the surface in the thickness direction to be melted in such a way, since the long resin foam sheet can be easily continuously provided while the decrease of the flexibility is suppressed to the utmost, and the tensile strength in the longitudinal direction is made high, and generation of breakage and tearing is suppressed, and since a foamed portion is returned to a non-foamed state (bulk), and the roughness of the surface (error in the thickness) originally present is thereby reduced and the thickness precision is improved, the generation of wrinkles (wind-up wrinkles in winding-up) can be suppressed even at a high speed. In the present description, a sheet-shape foam obtained by foaming the resin composition and before being subjected to a heat melting treatment is referred to as a “foam structure” in some cases.

The heat melting treatment is not especially limited, but is preferably carried out on all over at least one surface of the foam structure from the viewpoints of providing better wind-up stability and of improving the thickness precision by suppressing the generation of wrinkles in winding-up, particularly suppressing the generation of wrinkles at high-speed winding-up, by adjusting the “value determined by the expression (1)” and the rate of surface coverage. That is, in the case where the long resin foam sheet according to the present invention is formed by foaming the resin composition, and thereafter further subjecting the surface thereof to a heat melting treatment, it is preferable that after a foam structure is obtained by foaming the resin composition, the long resin foam sheet is formed by subjecting one surface or both surfaces of the foam structure to a heat melting treatment. The heat melting treatment may be carried out not less than twice on the same surface.

The heat melting treatment is not especially limited, but examples thereof include press treatment using a hot roll, laser irradiation treatment, contact melting treatment on a heated roll and flame treatment. In the case of the press treatment using a hot roll, the treatment can be suitably carried out using a heat laminator or the like. The material of the roll includes rubbers, metals and fluororesins (for example, Teflon®).

The temperature in the heat melting treatment is not especially limited, but is preferably not less than a temperature lower by 15° C. than a softening point or a melting point of a resin (for example, the polyolefin-based resin) contained in the resin foam sheet (more preferably not less than a temperature lower by 12° C. than the softening point or the melting point of the resin contained in the resin foam sheet), and preferably not more than a temperature higher by 20° C. than the softening point or the melting point of the resin contained in the resin foam sheet (more preferably not more than a temperature higher by 10° C. than the softening point or the melting point of the resin contained in the resin foam sheet). If the temperature in the heat melting treatment is higher than a temperature lower by 15° C. than a softening point or a melting point of a constituting resin, the temperature is preferable from the viewpoint of being capable of efficiently carrying out the heat melting treatment. By contrast, if the temperature in the heat melting treatment is lower than a temperature higher by 20° C. than the softening point or the melting point of the constituting resin, generation of wrinkles due to shrinkage can be suppressed, which is preferable.

The treatment time of the heat melting treatment, though depending on the treatment temperature, is, for example, preferably about 0.1 sec to 10 sec, and more preferably about 0.5 sec to 7 sec. This is because a too short time makes no progress of melting in some cases, and a too long time generates wrinkles and the like due to shrinkage in some cases.

The heat melting treatment especially preferably uses a heat melting treatment apparatus capable of adjusting a gap (spacing, interval) through which a foam structure passes, from the viewpoints of providing better wind-up stability and of improving the thickness precision by suppressing the generation of wrinkles in winding-up, particularly suppressing the generation of wrinkles at high-speed winding-up, by adjusting the “value determined by the expression (1)” and the rate of surface coverage.

An example of such a heat melting treatment apparatus includes a continuous treatment apparatus having a heating roll (thermodielectric roll) having an adjustable gap in FIG. 2.

The long resin foam sheet according to the present invention is low in the apparent density, thin and flexible, and excellent in the stability in winding-up (wind-up stability). Therefore, a wide and long roll can be provided. The long resin foam sheet according to the present invention can be raised in the thickness precision.

The long resin foam sheet according to the present invention is used suitably for applications such as dustproof materials, sealing materials (expansive sealing materials), soundproof materials and buffer materials, which are used when various types of members or parts are fixed (installed) on predetermined sites. The long resin foam sheet according to the present invention may be processed into a variety of shapes according to applications.

### [Resin Foam Composite Material]

The resin foam composite material according to the present invention comprises at least the long resin foam sheet according to the present invention. The resin foam composite material according to the present invention preferably has a structure in which the long resin foam sheet according to the present invention and another layer are laminated. The shape of the resin foam composite material according to the present invention is not especially limited, but is preferably a sheet-shape (film-shape) or a roll-shape. The resin foam composite material may be processed into a variety of shapes according to applications.

The another layer may be provided only on one surface side of the long resin foam sheet according to the present invention, or on both surface sides thereof. The another layer to be provided is at least one layer. The another layer may be a single layer or a laminate composed of a plurality of layers.

Examples of the another layer include pressure-sensitive adhesive layers, intermediate layers (for example, undercoat layers to improve close adherence) and base material layers (for example, film layers and nonwoven fabric layers).

Among these, the another layer is preferably a pressure-sensitive adhesive layer. That is, the resin foam composite material according to the present invention preferably has a pressure-sensitive adhesive layer at least on one surface side of the long resin foam sheet according to the present invention. That the resin foam composite material has a pressure-sensitive adhesive layer is advantageous for fixation or temporary fixation thereof on an adherend, and advantageous in assembling (laminating). A processing mount can be provided on the resin foam sheet through the pressure-sensitive adhesive layer.

A pressure-sensitive adhesive constituting the pressure-sensitive adhesive layer is not especially limited, but examples thereof include acrylic pressure-sensitive adhesives, rubber-based pressure-sensitive adhesives (natural rubber-based pressure-sensitive adhesives, synthetic rubber-based pressure-sensitive adhesives and the like), silicone-based pressure-sensitive adhesives, polyester-based pressure-sensitive adhesives, urethane-based pressure-sensitive adhesives, polyamide-based pressure-sensitive adhesives, epoxy-based pressure-sensitive adhesives, vinyl alkyl ether-based pressure-sensitive adhesives and fluorine-based pressure-sensitive adhesives. The pressure-sensitive adhesive may be used singly or in combinations of two or more. The pressure-sensitive adhesive may be a pressure-sensitive adhesive of any form of emulsion-based pressure-sensitive adhesives, solvent-based pressure-sensitive adhesives, hot-melt type pressure-sensitive adhesives, oligomer-based pressure-sensitive adhesives, solid-based pressure-sensitive adhesives and the like.

The thickness of the pressure-sensitive adhesive layer is not especially limited, but is preferably 2 to 100 μm, and more preferably 10 to 100 μm. Since the pressure-sensitive adhesive layer having a thinner layer has a larger effect of preventing adhesion of dirts and dusts to edges, a thinner one is preferable. The pressure-sensitive adhesive layer may be a single layer or a laminate.

The pressure-sensitive adhesive layer may be formed at least on one surface side of the long resin foam sheet according to the present invention through at least one layer of underlayer. Examples of such an underlayer include pressure-sensitive adhesive layers other than the above pressure-sensitive adhesive layer, intermediate layers, undercoat layers and base material layers. Among these, base material layers are preferable, and film layers such as plastic film layers, nonwoven fabric layers and the like are especially preferable, from the viewpoint of improving the breaking strength.

The long resin foam sheet according to the present invention or the resin foam composite material according to the present invention is not especially limited in applications, but is preferably used for applications in which various types of members or parts are fixed (installed) on predetermined sites. These are suitably used particularly when parts constituting electric or electronic devices are fixed (installed) on predetermined sites in the electric or electronic devices. That is, the long resin foam sheet according to the present invention and the resin foam composite material according to the present invention are preferably for electric or electronic devices.

The various types of members or parts are not especially limited, but examples thereof preferably include various types of members or parts in electric or electronic devices. Examples of such members or parts for electric or electronic devices include image display members (display sections) (particularly small-size image display members) installed on image display apparatuses such as liquid crystal displays, electroluminescence displays and plasma displays, and optical members or optical parts for cameras, lenses (particularly small-size cameras and lenses) and the like installed on apparatuses for mobile communications such as so-called “mobile phones” and “personal digital assistants”

More specifically, the long resin foam sheet according to the present invention or the resin foam composite material according to the present invention can be used around display sections such as LCDs (liquid crystal displays) and by being interposed between display sections such as LCDs (liquid crystal displays) and cases (window sections), for the purpose of dustproofing, light shielding, buffer and the like.

Since the long resin foam sheet according to the present invention is thin and flexible and can be raised in the thickness precision, even if the long resin foam sheet according to the present invention or the resin foam composite material according to the present invention is used for electric or electronic devices in which a large number of parts or members are stacked, like smart phones mounting touch panels, a high repulsive force is not caused and defective displaying such as liquid crystal displaying unevenness of display sections are not caused.

### EXAMPLES

Hereinafter, the present invention will be described in more detail by way of Examples, but the present invention is not limited to these Examples.

### EXAMPLES

45 parts by weight of a polypropylene [melt flow rate (MFR): 0.35 g/10-min], 55 parts by weight of a mixture (MFR (230° C.): 6 g/10-min, JIS A hardness: 79°, 30 parts by mass of a softening agent was blended in 100 parts by mass of a polyolefin-based elastomer) of the polyolefin-based elastomer and the softening agent (paraffin-based extension oil), 10 parts by weight of magnesium hydroxide, 10 parts by weight of carbon (trade name: “Asahi #35”, manufactured by Asahi Carbon Co., Ltd.), and 1 part by weight of monoglyceride stearate, and 1.5 parts by weight of a fatty acid amide (bisamide laurate) were kneaded at a temperature of 200° C. by a twin-screw kneading machine manufactured by Japan Steel Works, Ltd., and thereafter extruded in a strand-shape, water-cooled, and thereafter molded in a pellet-shape. The pellet was charged in a single-screw extruder manufactured by Japan Steel Works, Ltd.; and carbon dioxide gas was injected under an atmosphere of 220° C. and at a pressure of 13 MPa (after the injection, 12 MPa). The carbon dioxide gas was injected in a proportion of 5.6 wt % with respect to the total amount of the pellet. After the carbon dioxide gas was fully saturated, the charged pellet was cooled to a temperature suitable for foaming, thereafter extruded in a cylindrical shape from a die, and thereafter passed between a mandrel to cool the inner-side surface of the foam and a foam-cooling air ring to cool the outer-side surface of the cylindrical foam extruded from the cyclic die of the extruder; and a part of the diameter of the foam was cut to unfold the foam into a sheet-shape to thereby obtain a long foam raw sheet. In the long foam raw sheet, the average cell diameter was 55 μm, and the apparent density was 0.041 g/cm³.

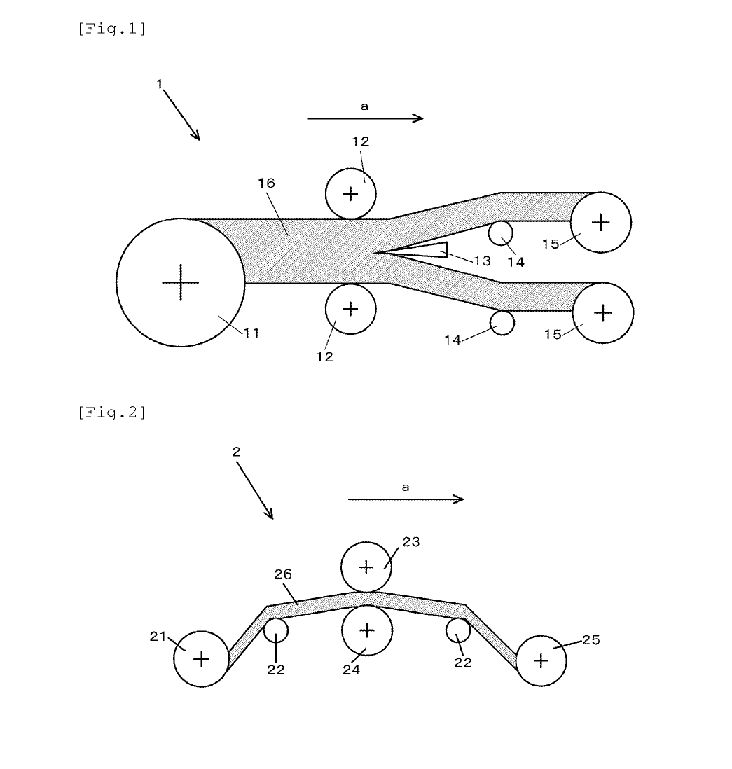

The long foam raw sheet was cut (slit-processed) in a predetermined width; and a low-foamed layer of the surface of each side was peeled off using a continuous slicing apparatus (slicing line) shown in FIG. 1 to thereby obtain a resin foam A and a resin foam B. Resin foam A: thickness: 0.30 mm, width: 550 mm Resin foam B: thickness: 0.40 mm, width: 550 mm

### Example 1

The resin foam A was passed in the above continuous treatment apparatus in which the temperature of an induction heating roll was set at 160° C. and the gap was set at 0.20 mm, to thereby subject one surface thereof to a heat melting treatment, slit-processed, and thereafter wound up to thereby obtain a resin foam sheet whose one surface had been subjected to the heat melting treatment. Here, the take-off speed was set at 20 m/min.

### Example 2

The resin foam B was passed in the above continuous treatment apparatus in which the temperature of an induction heating roll was set at 160° C. and the gap was set at 0.30 mm, to thereby subject one surface thereof to a heat melting treatment, slit-processed, and thereafter wound up to thereby obtain a resin foam sheet whose one surface had been subjected to the heat melting treatment. Here, the take-off speed was set at 20 m/min.

### Example 3

The resin foam A was passed in the above continuous treatment apparatus in which the temperature of an induction heating roll was set at 160° C. and the gap was set at 0.20 mm, to thereby subject one surface thereof to a heat melting treatment, slit-processed, and thereafter wound up to thereby obtain a wound body. Here, the take-off speed was set at 20 m/min.

Then, the wound body was rewound, passed in the above continuous treatment apparatus in which the temperature of an induction heating roll was set at 160° C. and the gap was set at 0.10 mm, to thereby subject the surface (untreated surface) thereof having been subjected to no heat melting treatment to a heat melting treatment, slit-processed, and thereafter wound up to thereby obtain a resin foam sheet whose both surfaces had been subjected to the heat melting treatments. Here, the take-off speed was set at 20 m/min.

### Example 4

The resin foam B was rewound, passed in the above continuous treatment apparatus in which the temperature of an induction heating roll was set at 160° C. and the gap was set at 0.30 mm, to thereby subject one surface thereof to a heat melting treatment, slit-processed, and thereafter wound up to thereby obtain a wound body. Here, the take-off speed was set at 20 m/min.

Then, the wound body was rewound, passed in the above continuous treatment apparatus in which the temperature of an induction heating roll was set at 160° C. and the gap was set at 0.20 mm, to thereby subject the surface (untreated surface) thereof having been subjected to no heat melting treatment to a heat melting treatment, slit-processed, and thereafter wound up to thereby obtain a resin foam sheet whose both surfaces had been subjected to the heat melting treatments. Here, the take-off speed was set at 20 m/min.

### Example 5

The resin foam A was passed in the above continuous treatment apparatus in which the temperature of an induction heating roll was set at 160° C. and the gap was set at 0.25 mm, to thereby subject one surface thereof to a heat melting treatment, and wound up to thereby obtain a wound body. Here, the take-off speed was set at 20 m/min.

Then, the wound body was rewound, passed in the above continuous treatment apparatus in which the temperature of an induction heating roll was set at 160° C. and the gap was set at 0.20 mm, to thereby subject the surface thereof having previously been subjected to the melting treatment to a heat melting treatment, slit-processed, and thereafter wound up to thereby obtain a resin foam sheet whose same surface had been twice subjected to the heat melting treatment. Here, the take-off speed was set at 20 m/min.

### Example 6

The resin foam A was passed in the above continuous treatment apparatus in which the temperature of an induction heating roll was set at 160° C. and the gap was set at 0.20 mm, to thereby subject one surface thereof to a heat melting treatment, and wound up to thereby obtain a wound body. Here, the take-off speed was set at 20 m/min.

Then, the wound body was rewound, passed in the above continuous treatment apparatus in which the temperature of an induction heating roll was set at 160° C. and the gap was set at 0.13 mm, to thereby subject the surface thereof having previously been subjected to the melting treatment to a heat melting treatment, slit-processed, and thereafter wound up to thereby obtain a resin foam sheet whose same surface had been twice subjected to the heat melting treatment. Here, the take-off speed was set at 20 m/min.

### Comparative Example 1

The resin foam A was passed in the above continuous treatment apparatus in which the temperature of an induction heating roll was set at 30° C. and the gap was set at 1.00 mm, slit-processed, and thereafter wound up to thereby obtain a resin foam sheet. Here, the take-off speed was set at 20 m/min.

### [Evaluations]

The resin foam sheets obtained in the Examples and the Comparative Example were measured or evaluated for the below. The results are shown in Table 1.

### (Apparent Density)

The resin foam sheet was stamped out with a stamping knife of 40 mm wide and 40 mm long to thereby obtain a measuring sample. Then, the apparent density (g/cm³) of the measuring sample was determined according to JIS K 6767.

Specifically, the width and length of the measuring sample were measured, and the thickness (mm) of the measuring sample was measured with a 1/100 dial gage whose measurement terminals had a diameter (O) of 20 mm. The volume (cm³) of the polyolefin-based resin foam was calculated from these measurement values. Then, the weight (g) of the measuring sample was measured with an even balance of not less than 0.01 g in minimum scale value. The apparent density (g/cm³) was calculated from the above volume and the measurement value of the weight.

### (Repulsive Stress at 50%-Compression)

According to JIS K 6767, a stress (N) when the resin foam sheet was compressed to 50% of the initial thickness in the thickness direction was measured, converted to a value per unit area (cm²), and made the value to be a repulsive stress (N/cm²) at 50%-compression.

### (Tensile Strength)

According to the section of the tensile strength and elongation of JIS K 6767, a tensile strength (MPa) in the longitudinal direction of the resin foam sheet was measured.

### (Thickness, Thickness Tolerance (Thickness Range), Central Value of Thicknesses, “Value Determined by Expression (1)”, Standard Deviation in Thickness)

A measurement, in which the thicknesses were measured every 10 mm from one edge to the other edge in the width direction at a point in the longitudinal direction of the resin foam sheet, and the thicknesses were further measured every 10 mm from one edge to the other edge in the width direction at a point moved in the longitudinal direction by 1 m from the former point, was carried out, and an average value, a maximum value and a minimum value were determined from all the measurement values acquired.

When the thickness was measured, a 1/100 dial gage whose measurement terminals had a diameter (φ) of 20 mm was used.

The average value of the measurement values was made to be a “thickness” (mm) of the resin foam sheet.

A difference between the maximum value and the minimum value was made to be a “thickness tolerance (thickness range)” (mm).

A value positioned at the center in all measurement values arranged in ascending order was made to be a “central value of thicknesses” (mm).

A standard deviation was determined from the measurement values, and was made to be a “standard deviation in thickness”.

A “value determined by expression (1)” was calculated from the following expression (1).

(Thickness Tolerance)/(Central Value of Thicknesses)×100 (1)

### (Rate of Surface Coverage)

A rate of surface coverage of the surface having been subjected to a heat melting treatment of the resin foam sheet was measured, and an acquired value was made to be a rate of surface coverage of the resin foam sheet. In the case where both the surfaces were surfaces having been subjected to a heat melting treatment, rates of surface coverage of both the surfaces were determined, and the lower value thereof was made to be a rate of surface coverage of the resin foam sheet. Further in the case where both the surfaces were surfaces having been subjected to no heat melting treatment, a rate of surface coverage of any one surface thereof was measured, and the value was made to be a rate of surface coverage of the resin foam sheet.

The rate of surface coverage was determined by the following expression (2).

Rate of surface coverage(%)=[(Area of Surface)−(Area of Pores Present on the Surface)]/(the Area of the Surface)×100 (2)

The area of the surface and the area of pores present on the surface were determined from an image of the measurement surface acquired using a microscope (instrument name: “VHX600”, manufactured by Keyence Corporation).

In the observation by the microscope, an illumination method used a lateral illumination, and the illuminance was made to be 17,000 lx. The magnification was set at 500×.

As an illumination-cum-camera, an illumination-built-in lens camera (instrument name: “OP72404”, manufactured by Keyence Corporation) was used, and as a lens, a zoom lens (trade name: “VH-Z100”, manufactured by Keyence Corporation) was used.

The illuminance was regulated using an illuminometer (trade name: “VHX600”, manufactured by Custom Corporation).

### (Thickness Precision)

A thickness precision was determined by the following expression (3).

An objective value was an aiming thickness value (objective thickness value). For example, the objective value of Example 1 was 0.20 mm, which was a set magnitude of the gap; and the objective value of Example 3 was 0.10 mm, which was a finally set magnitude of the gap.

Thickness Precision(%)=[(Thickness Tolerance)/2]/(Objective Value)×100 (3)

### (Evaluation of Wind-Up Stability)

Whether or not tearing and breakage were generated when the resin foam sheet was wound up in making the resin foam sheet, and whether or not wrinkles (wind-up wrinkles) were generated in the wound up wound body, were checked, and evaluated according to the following criterion.

Evaluation Criterion

“No problem”: neither tearing nor breakage were generated and no wrinkles were generated.

“Wrinkle generated”: wrinkles were generated. [Table 1]

TABLE 1

| | | | | | | | Comparative |
|---|---|---|---|---|---|---|---|
| | Example 1 | Example 2 | Example 3 | Example 4 | Example 5 | Example 6 | Example 1 |
| Thickness [mm] | 0.21 | 0.30 | 0.11 | 0.20 | 0.21 | 0.13 | 0.32 |
| Length [m] | 100 | 300 | 100 | 100 | 100 | 100 | 100 |
| Width [mm] | 500 | 500 | 500 | 500 | 300 | 300 | 500 |
| Apparent Density | 0.06 | 0.057 | 0.151 | 0.108 | 0.057 | 0.101 | 0.041 |
| [g/cm³] | | | | | | | |
| Tensile Strength | 1.94 | 1.68 | 3.3 | 2.43 | 1.86 | 3.11 | 1.25 |
| [MPa] | | | | | | | |
| Compression Stress | 1.52 | 1.58 | 2.08 | 1.82 | 1.62 | 2.12 | 1.56 |
| at 50%-Compression | | | | | | | |
| [N/cm²] | | | | | | | |
| Thickness Tolerance | 0.05 | 0.04 | 0.02 | 0.02 | 0.02 | 0.02 | 0.1 |
| [mm] | | | | | | | |
| Central Value of | 0.21 | 0.31 | 0.10 | 0.20 | 0.21 | 0.13 | 0.33 |
| Thicknesses [mm] | | | | | | | |
| Value Determined by | 23.8 | 12.9 | 20.0 | 10.0 | 9.5 | 15.4 | 30.3 |
| Expression (1) [%] | | | | | | | |
| Standard Deviation | 0.009 | 0.01 | 0.006 | 0.007 | 0.005 | 0.007 | 0.026 |
| in Thickness | | | | | | | |
| Rate of surface | 86.2 | 88.7 | 84.5 | 86.3 | 94.2 | 96.1 | 33.6 |
| coverage [%] | | | | | | | |
| Aiming Thickness | 0.2 | 0.3 | 0.1 | 0.2 | 0.20 | 0.13 | 0.3 |
| [mm] | | | | | | | |
| Thickness Precision | 12.5 | 6.7 | 10 | 5 | 5.0 | 7.7 | 16.7 |
| [%] | | | | | | | |
| Wind-up Stability | No | No | No | No | No | No | Wrinkle |
| | problem | problem | problem | problem | problem | problem | generated |

### INDUSTRIAL APPLICABILITY

The resin foam sheet and the resin foam composite material according to the present invention are used, for example, for applications such as dustproof materials, sealing materials, soundproof materials and buffer materials, which are used when various types of members or parts are fixed on predetermined sites.

### REFERENCE SIGNS LIST

1 CONTINUOUS SLICING APPARATUS (SLICING LINE)
11 SUPPLY ROLL
10 PINCH ROLL
13 KNIFE (SLICING KNIFE)
14 GUIDE ROLL
15 WIND-UP ROLL
16 RESIN FOAM
2 CONTINUOUS TREATMENT APPARATUS HAVING HEATING ROLL
21 SUPPLY ROLL
22 GUIDE ROLL
23 HEATING ROLL (THERMODIELECTRIC ROLL)
24 COOLING ROLL
25 WIND-UP ROLL
26 RESIN FOAM
a FLOWING DIRECTION

1. A resin foam sheet, having: an apparent density of 0.03 to 0.30 g/cm³, a compression stress at 50%-compression of not more than 5.0 N/cm², a thickness of not less than 0.05 mm and not more than 0.40 mm, a length of not less than 5 m, and a width of not less than 300 mm.

2. The resin foam sheet according to claim 1, wherein the resin foam sheet has a value of not more than 25% determined by the following expression (1):
(thickness tolerance)/(central value of thicknesses)×100 (1),
wherein the thickness tolerance refers to a difference between a maximum value and a minimum value in all measurement values acquired by a measurement wherein thicknesses are measured every 10 mm from one edge to the other edge in a width direction at a point in a longitudinal direction, and thicknesses are further measured every 10 mm from one edge to the other edge in the width direction at a point moved in the longitudinal direction by 1 m from the former point; and
the central value of thicknesses refers to a value positioned at the center in all measurement values arranged in ascending order acquired by a measurement wherein thicknesses are measured every 10 mm from one edge to the other edge in a width direction at a point in a longitudinal direction, and thicknesses are further measured every 10 mm from one edge to the other edge in the width direction at a point moved in the longitudinal direction by 1 m from the former point.

3. The resin foam sheet according to claim 1, wherein at least one surface of the resin foam sheet has a rate of surface coverage of not less than 40% defined by the following expression (2):
rate of surface coverage(%)=[(area of a surface)−(area of pores present on the surface)]/(the area of the surface)×100 (2).

4. The resin foam sheet according to claim 1, wherein the resin foam sheet is formed by foaming a resin composition and further subjecting a surface of the resin composition to a heat melting treatment.

5. A resin foam composite material, comprising: a resin foam sheet according to claim 1, and a pressure-sensitive adhesive layer at least on one surface side of the resin foam sheet.
